(19) United States
(12) Patent Application Publication
(10) Pub. No.: US 2018/0286604 A1
(43) Pub. Date: Oct. 4, 2018

(54) REACTION FORCE GENERATING MEMBER AND KEY SWITCH DEVICE

(71) Applicant: FUJITSU COMPONENT LIMITED, Tokyo (JP)

(72) Inventor: Shinnosuke OKUTANI, Tokyo (JP)

(73) Assignee: FUJITSU COMPONENT LIMITED, Tokyo (JP)

(21) Appl. No.: 15/886,253

(22) Filed: Feb. 1, 2018

(30) Foreign Application Priority Data
Mar. 30, 2017 (JP) 2017-069263

(51) Int. Cl. H01H 13/14; H01H 13/705; H01H 13/20

(52) U.S. Cl. CPC H01H 13/14; H01H 2215/004; H01H 13/20; H01H 13/705

(57) ABSTRACT

A reaction force generating member includes: a first dome that gives a reaction force to an operation member according to the depression of the operation member; and a second dome that includes a hemispherical bowl part disposed inside the first dome, and a projection projecting downward from the center of the bowl part and depressing a switch disposed below the operation member.

### CROSS-REFERENCE TO RELATED APPLICATION

This application is based upon and claims the benefit of priority of the prior Japanese Patent Application No. 2017-069263 filed on Mar. 30, 2017, the entire contents of which are incorporated herein by reference.

### FIELD

A certain aspect of the embodiments is related to a reaction force generating member and a key switch device.

### BACKGROUND

Conventionally, there has been known a key switch device using a dome rubber arranged between a membrane sheet and a key top (see Patent Document 1; Japanese Laid-open Patent Publication No. 2015-133309). The dome rubber includes an outer dome that gives a reaction force according to elastic deformation to the key top, and an inner dome that depresses a contact of the membrane sheet.

In the key switch, the operation force increases until a load which acts on the outer dome of the dome rubber reaches a buckling load of the outer dome. When the load which acts on the outer dome reaches the buckling load of the outer dome, the operation force decreases gradually with the increase in a keystroke. Then, the contact is turned on in a process in which the operation force is decreasing. Therefore, an operator gets a feeling of a click by acquiring a peak (maximum) operation force by the buckling deformation of the outer dome. Since the contact is turned on in the process in which the operation force is decreasing, an operation feeling sufficiently corresponds to a contact depression operation, and hence the operability of the key switch device is improved.

### SUMMARY

According to an aspect of the present invention, there is provided a reaction force generating member including: a first dome that gives a reaction force to an operation member according to the depression of the operation member; and a second dome that includes a hemispherical bowl part disposed inside the first dome, and a projection projecting downward from the center of the bowl part and depressing a switch disposed below the operation member.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is an exploded perspective view illustrating a key switch device according to a present embodiment;

FIG. 1B is a diagram illustrating a computer including a keyboard on which a plurality of key switch devices are arranged;

FIG. 2A is a cross-section diagram of a dome rubber according to a present embodiment;

FIG. 2B is a cross-section diagram of a dome rubber according to a comparative example;

FIG. 3A is a diagram illustrating a load displacement characteristic of the dome rubber according to the present embodiment;

FIG. 3B is a diagram illustrating a load displacement characteristic of the dome rubber according to the comparative example;

FIGS. 4A to 4D are diagrams illustrating transition states of the deformation of the dome rubber according to the present embodiment;

FIGS. 4E to 4H are diagrams illustrating transition states of the deformation of the dome rubber according to the comparative example;

FIG. 5A is a diagram illustrating a deformation state of the dome rubber according to the present embodiment when the key top is inclined;

FIG. 5B is a diagram illustrating a deformation state of the dome rubber according to the comparative example when the key top has been inclined and an inner dome has caused buckling deformation; and

FIG. 5C is a diagram illustrating a deformation state of the dome rubber according to the comparative example when the inner dome has inverted.

### DESCRIPTION OF EMBODIMENTS

In the key switch device of the Patent Document 1, since the key top is tilted when a corner of the key top is depressed, the load is not applied evenly left and right to the outer dome and the inner dome. Therefore, there is a possibility that the inner dome causes the buckling deformation. When the inner dome causes the buckling deformation, a desired load characteristic of the dome rubber is not obtained and a deviation occurs between the operation feeling and the contact depression operation, thereby causing an uncomfortable feeling to an operator.

A description will now be given of an embodiment of the present invention with reference to the drawings.

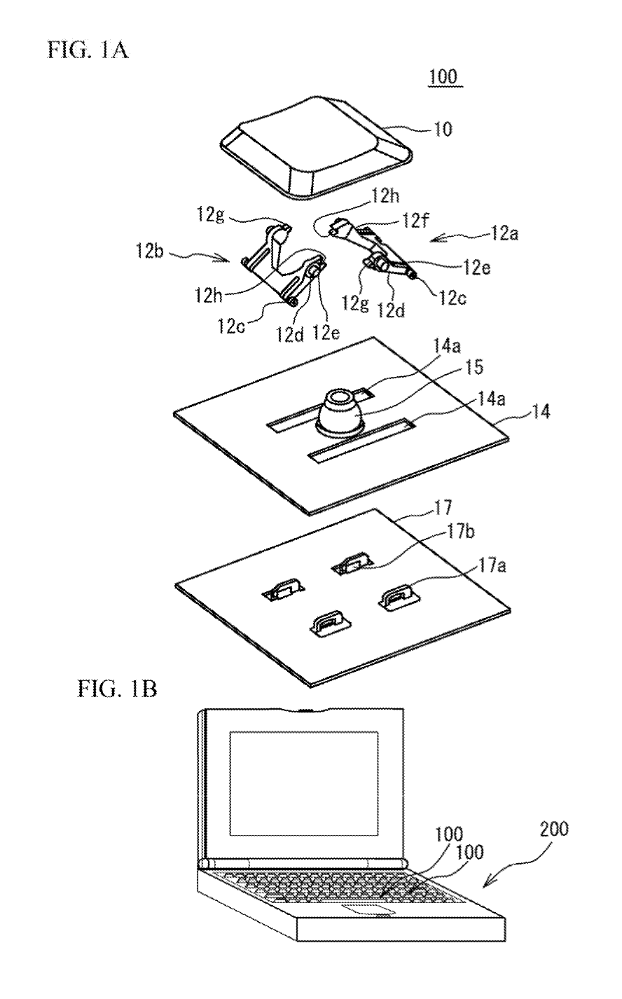

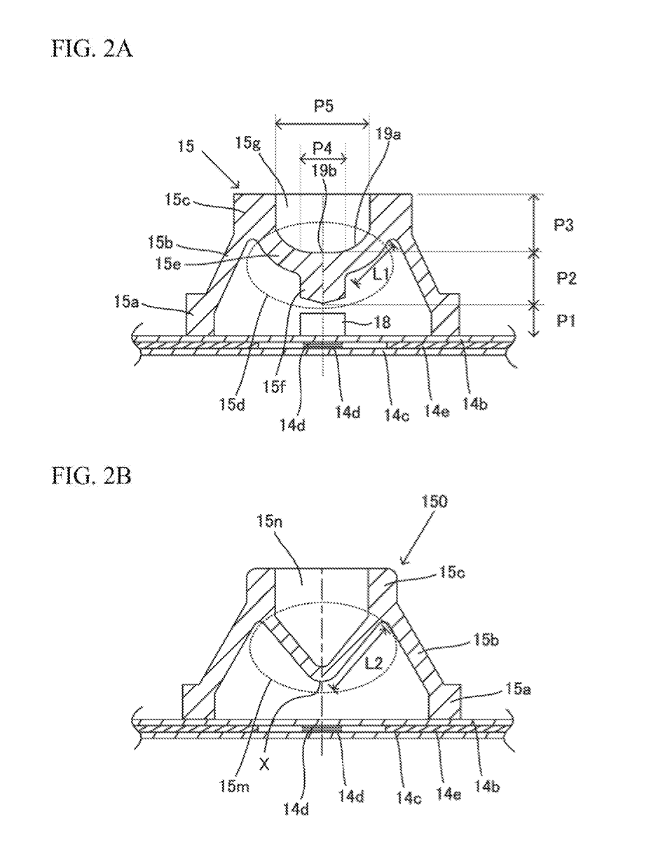

FIG. 1A is an exploded perspective view illustrating a key switch device according to a present embodiment. FIG. 1B is a diagram illustrating a computer including a keyboard on which a plurality of key switch devices are arranged. FIG. 2A is a cross-section diagram of a dome rubber according to a present embodiment. FIG. 2B is a cross-section diagram of a dome rubber according to a comparative example.

A key switch device 100 includes a key top 10 functioning as an operation member, two gear links 12a and 12b, a membrane sheet 14, and a support panel 17, as illustrated in FIG. 1A. On a keyboard 200, a plurality of key switch devices 100 are arranged, as illustrated in FIG. 1B. Here, in the keyboard 200 of FIG. 1B, the single membrane sheet 14 and the single support panel 17 corresponding to the plurality of key switch devices 100 are used.

The membrane sheet 14 includes sheet substrates 14b and 14c, a spacer 14e arranged between the sheet substrates 14b and 14c, and a pair of contacts 14d functioning as a switch, as illustrated in FIG. 2A. The sheet substrates 14b and 14c are separated via the spacer 14e by a given distance. The pair of contacts 14d are formed at positions of the sheet substrates 14b and 14c on which the spacer 14e is not provided, so as to be opposite to each other, respectively. A dome rubber 15 as a reaction force generating member is fixed on the membrane sheet 14.

The dome rubber 15 is a dome-shaped member composed of a rubber material by integral molding. The dome rubber 15 includes a ring-shaped base part 15a, an outer dome 15b as a first dome extending obliquely from the base part 15a, a cylindrical part 15c extending vertically upward from the outer dome 15b, and an inner dome 15d as a second dome extending downward from the cylindrical part 15c. The outer dome 15b elastically deforms according to a depression force. An upper end of the cylindrical part 15c contacts a rear surface of the key top 10.

A place surrounded by the base part 15a, the outer dome 15b and the inner dome 15d is a space, and an air hole 18 is formed on the base part 15a. The inner dome 15d includes a hemispherical bowl part 15e extending downward from the cylindrical part 15c, and a projection 15f projecting downward from the center of the bowl part 15e. Since the projection 15f is provided in the center of the bowl part 15e, the center of the bowl part 15e is thicker than an outer circumference of the bowl part 15e. Therefore, when the projection 15f is in contact with the membrane sheet 14 and the key top 10 is depressed, the bowl part 15e is deformed upward, but the projection 15f does not bend and does not cause the buckling deformation. In the present embodiment, the buckling deformation is deformation in which a load level decreases according to the increase in stroke. The cylindrical part 15c includes a recess 15g housing the inner dome 15d (i.e., the bowl part 15e which is deformed upward and the projection 15f).

A dome rubber 150 of a comparative example illustrated in FIG. 2B includes an inner dome 15m having an inverse cone shape. The cylindrical part 15c of the dome rubber 150 includes a recess 15n housing the inner dome 15m. The dome rubber 15 differs from the dome rubber 150 in the shapes of the inner dome and the recess, and the other configurations of the dome rubber 15 are the same as those of the dome rubber 150.

A length L1 of a deformable portion (i.e., a part from the cylindrical part 15c to the projection 15f) of the inner dome 15d in FIG. 2A is shorter than a length L2 of a deformable portion (i.e., a part from the cylindrical part 15c to an apex X) of the inner dome 15m in FIG. 2B.

In the case of FIG. 2B, since the length L2 is longer than the length L1, when the thicknesses of the left and right of the inner dome 15m are different by the doneness of a mold, the dome rubber 150 is susceptible to uneven deformation. On the contrary, in the dome rubber 15 of FIG. 2A, since the projection 15f is provided in the center of the bowl part 15e, it is possible to shorten the length L1 of the deformable portion of the inner dome 15d, and therefore the dome rubber 15 is hardly affected by the uneven deformation.

With the increase in the stroke, the inner dome is housed in the recess while being tightly stretched. Therefore, a load applied to the deformable portion of the inner dome 15m having the inverted cone shape of FIG. 2B is large, and the product life of the dome rubber 150 may be shortened. Moreover, in the case of the dome rubber 150, when the key top 10 is depressed beyond a stroke end, the inner dome 15m is reversed and may not return to the shape of FIG. 2B. On the contrary, since the deformable portion of the inner dome 15d in FIG. 2A has a bowl shape, when the deformed portion is housed in the recess 15g, the load can be reduced and no reversal of the deformable portion occurs.

An upper surface 19a of the bowl part 15e of the inner dome 15d in FIG. 2A has a spherical shape, and in particular, an upper surface 19b of the bowl part 15e located above the projection 15f has a gentle spherical shape or planar shape. This is because, when the cross section of the upper surfaces 19a and 19b of the bowl part 15e has a V-shape of FIG. 2B, the inner dome 15d is easy to cause the buckling deformation and it is not possible to obtain a desired load displacement characteristic of the dome rubber 15.

A length P2 from the upper surface 19b of the bowl part 15e to an apex pf the projection 15f illustrated in FIG. 2A is shorter than a length P3 from the upper surface 19b of the bowl part 15e to an upper end of the cylindrical part 15c. Moreover, a horizontal length P4 of the upper surface 19b of the bowl part 15e is shorter than a length P5 of the inner diameter of the cylindrical part 15c. These are because of housing the inner dome 15d in the recess 15g to thereby ensure a longer stroke.

Returning to FIG. 1A, the support panel 17 is disposed under the key top 10 and the membrane sheet 14 is disposed between the key top 10 and the support panel 17. An upper surface of the support panel 17 is opposite to a lower surface of the membrane sheet 14. The support panel 17 includes four regulation parts 17a that regulate the movement in a vertical direction of shafts 12c of the gear links 12a and 12b. Each of the regulation parts 17a is vertically formed to the support panel 17, and includes an approximately rectangle hole 17b into which the shaft 12c moving in a horizontal direction is inserted. A part of the upper surface of the support panel 17 and the regulation parts 17a are exposed from holes 14a provided in the membrane sheet 14.

As illustrated in FIG. 1A, projections 12e are provided on apical parts 12d of the gear links 12a and 12b and are rotatably fixed to the rear surface of the key top 10. The shafts 12c are formed in the rear ends of the gear links 12a and 12b, and are inserted into holes 17b of the regulation parts 17a. Thereby, the gear links 12a and 12b are movably fixed to the support panel 17.

A first tooth 12g is provided on one of the apical parts 12d of the gear link 12a (i.e., the apical part 12d of a front side in FIG. 1A), and a second tooth 12h is provided on another one of the apical parts 12d (i.e., the apical part 12d of a back side in FIG. 1A). The first tooth 12g and the second tooth 12h are provided on the gear link 12b. The first tooth 12g of the gear link 12a engages with the second tooth 12h of the gear link 12b, and the second tooth 12h of the gear link 12a engages with the first tooth 12g of the gear link 12b. Thus, the pair of gear links 12a and 12b are coupled at the apical parts 12d, and can operate simultaneously with each other. Arm parts 12f extend from the apical parts 12d toward the shafts 12c.

When the key top 10 is not depressed (at the time of un-depressing), the two gear links 12a and 12b are assembled in the shape of a reverse V-character, and support the key top 10. When the key top 10 is depressed with an operator's finger (at the time of depression) for example, the rear surface of the key top 10 depresses the dome rubber 15. Thereby, the dome rubber 15 performs buckling deformation, the projection 15f of the inner dome 15d depresses the membrane sheet 14, and the contact 14d is turned on. When the finger is lifted from the key top 10, the key top 10 is pushed upwards by the elastic force in an upper direction of the outer dome 15b and the inner dome 15d. The rear ends of the gear links 12a and 12b are slid in the horizontal direction with depression of the key top 10. Then, the arm parts 12f fall down. Thus, the gear links 12a and 12b guide the key top 10 in the vertical direction while keeping the key top 10 horizontally.

In FIG. 1A, the two gear links 12a and 12b are assembled in the shape of the reverse V-character, and support the key top 10. However, the two gear links 12a and 12b may be assembled in the shape of a V-character.

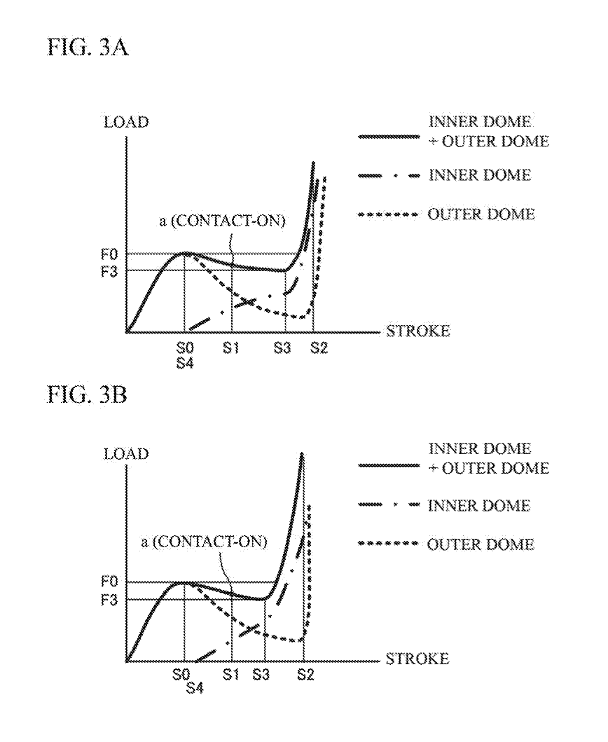

Hereinafter, a description will be given of a relationship between a stroke S of the key top 10 (i.e., an amount of depression) and a load (i.e., a depression force) F. FIG. 3A is a diagram illustrating a load displacement characteristic of the dome rubber 15, and FIG. 3B is a diagram illustrating a load displacement characteristic of the dome rubber 150 according to the comparative example. Here, in FIGS. 3A and 3B, the stroke S is set to a horizontal axis, the load F is set to a vertical axis, and a point “a” of contact-ON is illustrated additionally. A code F0 indicates a peak load, and a code F3 indicates a bottom load which is a minimum load after a peak load. A code S0 indicates a stroke corresponding to the peak load F0. A code S1 indicates a stroke at the time of turning ON of the contact 14d. A code S2 indicates the stroke end. A code S3 indicates a stroke corresponding to the bottom load F3. A code S4 indicates a stroke when a lower end of the projection 15f or an apex X of the inner dome 15m is in contact with the membrane sheet 14.

In FIG. 3A, a dotted line indicates the load displacement characteristic of the outer dome 15b, an alternate long and short dash line indicates the load displacement characteristic of the inner dome 15d, and a solid line indicates the total of the load displacement characteristics of the outer dome 15b and the inner dome 15d, i.e., the load displacement characteristic of the dome rubber 15.

When the load F of the key top 10 increases from 0, the stroke S also increases from 0 with the increase in the load F, as illustrated in FIG. 3A. At this time, the outer dome 15b performs the elastic deformation, and the reaction force from the outer dome 15b acts on the key top 10. The load F rises until the load which acts on the dome rubber 15 reaches a buckling load (i.e., the load F0) of the dome rubber 15. When the load which acts on the dome rubber 15 reaches the buckling load, subsequently the load F decreases gently with the increase in the stroke S. A peak load F0 is obtained by the elastic buckling deformation of the dome rubber 15, and hence the operator can get a particular click feeling in a key touch operation.

In this case, a stroke S4 corresponds to an initial length P1 between the lower end of the projection 15f and the membrane sheet 14 (see FIG. 2A). This length P1 can be set by adjusting the length of the projection 15f. The stroke S4 can be changed by adjusting the length P1, and hence the stroke S1 of the key top 10 at the time of contact-ON can be changed. That is, by adjusting the length P1, the stroke S1 of the key top 10 at the time of contact-ON can be set arbitrarily.

In the present embodiment, the stroke S1 is set to a value that is larger than a stroke S0 in which the peak load F0 is generated, and that is smaller than a stroke S3 corresponding to the bottom load F3 (for example, a middle value between the strokes S0 and S3). Thereby, since the contact 14d is turned on in a reduction domain of the load F after the operator gets the click feeling, an operator's operation feeling sufficiently corresponds to the ON-operation of the contact 14d, and hence the operability of the key switch improves.

In FIG. 3A, the stroke S0 and the stroke S4 overlap with each other. That is, while the outer dome 15b reaches the buckling load (i.e., the peak load F0), the lower end of the projection 15f is in contact with the membrane sheet 14. However, the stroke S4 may be disposed slightly to the right of the stroke S0, as illustrated in FIG. 3B. In this case, after the outer dome 15b reaches the buckling load (i.e., the peak load F0), the apex of the projection 15f is in contact with the membrane sheet 14.

In a section between the stroke S0 corresponding to the peak load and the stroke S3 corresponding to the bottom load, i.e., a section where the load level reduces (hereinafter referred to as “a click section”), a load reduction amount of the outer dome 15b is slightly larger than that of the inner dome 15d. For this reason, in the click section, the load displacement characteristic of the dome rubber 15 (i.e., the solid line) gently reduces.

By the way, in the click section, the load displacement characteristic of the inner dome 15d of FIG. 3A (i.e., the alternate long and short dash line) gently increases, but the load displacement characteristic of the inner dome 15m of FIG. 3B (i.e., the alternate long and short dash line) linearly increases. That is, in the click section, the load displacement characteristic of the inner dome 15d of FIG. 3A is lowered in a load increase rate more than the load displacement characteristic of the inner dome 15m of FIG. 3B. This is because, since the inner dome 15d does not perform the buckling deformation but the deformation close to the buckling deformation, it is possible to lower the load increase rate for a given section.

Thus, since in the click section, the load displacement characteristic of the inner dome 15d of FIG. 3A is lowered in a load increase rate more than the load displacement characteristic of the inner dome 15m of FIG. 3B, the stroke S3 corresponding to the bottom load of FIG. 3A is greater than the stroke S3 of FIG. 3B, which can make the click section longer and obtain more comfortable operation feeling.

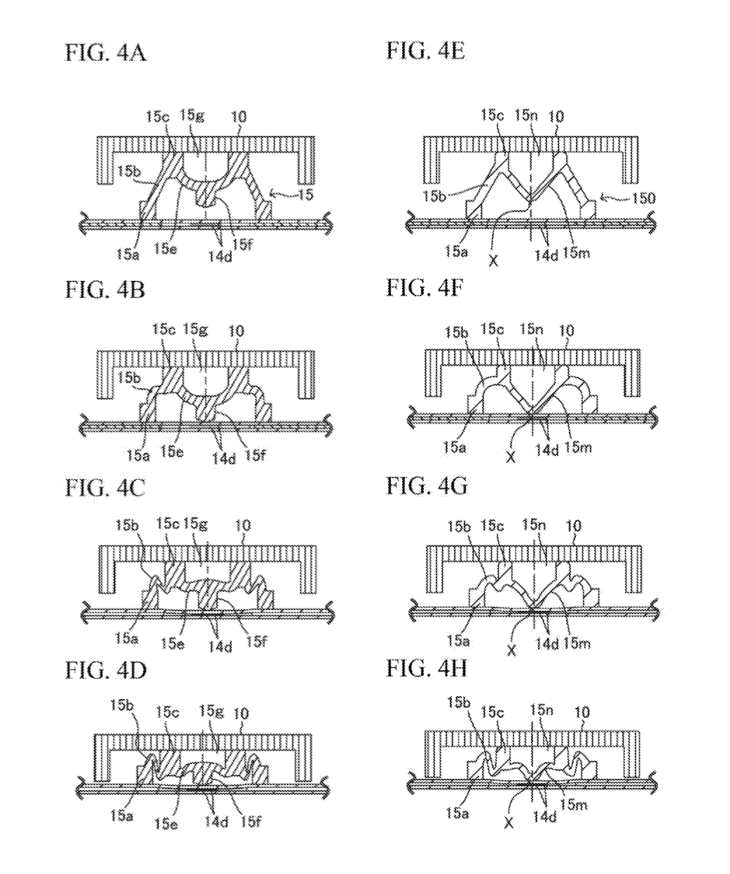

FIGS. 4A to 4D are diagrams illustrating transition states of the deformation of the dome rubber 15. FIGS. 4E to 4H are diagrams illustrating transition states of the deformation of the dome rubber 150.

FIG. 4A illustrates a state of the dome rubber 15 when the load F is 0 and the stroke S is 0 in FIG. 3A. FIG. 4E illustrates a state of the dome rubber 150 when the load F is 0 and the stroke S is 0 in FIG. 3B.

FIG. 4B illustrates a state of the dome rubber 15 when the load F is F0 and the stroke S is S0 and S4 in FIG. 3A. In FIG. 4B, the apex of the projection 15f is in contact with the membrane sheet 14 simultaneously with or immediately after the outer dome 15b performs the buckling deformation. FIG. 4F illustrates a state of the dome rubber 150 when the load F is F0 and the stroke S is S4 in FIG. 3B. In FIG. 4F, the apex X of the inner dome 15m is in contact with the membrane sheet 14 immediately after the outer dome 15b performs the buckling deformation.

FIG. 4C illustrates a state of the dome rubber 15 when the stroke S is S1 in FIG. 3A. The outer dome 15b continues the buckling deformation, and the load displacement characteristic of the outer dome 15b is a tendency to decrease. The inner dome 15d depresses the membrane sheet 14, and the contact 14d is turned on. Moreover, the bowl part 15e of the inner dome 15d deforms so that the inner dome 15d is housed in the recess 15g. The load displacement characteristic of the inner dome 15d is a tendency to increase. The total of the load displacement characteristics of the outer dome 15b and the inner dome 15d is the tendency to decrease.

FIG. 4G illustrates a state of the dome rubber 150 when the stroke S is S1 in FIG. 3B. The outer dome 15b continues the buckling deformation, and the load displacement characteristic of the outer dome 15b is the tendency to decrease. The inner dome 15m depresses the membrane sheet 14, and the contact 14d is turned on. Moreover, the inner dome 15m deforms so that the inner dome 15m is housed in the recess 15n. The load displacement characteristic of the inner dome 15m is a tendency to increase linearly. The total of the load displacement characteristics of the outer dome 15b and the inner dome 15m is the tendency to decrease.

FIG. 4D illustrates a state of the dome rubber 15 when the load F is F3 and the stroke S is S3 in FIG. 3A. In FIG. 4D, the deformable state of the inner dome 15d is finished, and then the load displacement characteristic of the inner dome 15d is a tendency to increase significantly. In FIG. 4D, the click section is finished.

FIG. 4H illustrates a state of the dome rubber 150 when the load F is F3 and the stroke S is S3 in FIG. 3B. In FIG. 4H, the deformable state of the inner dome 15m is finished, and then the load displacement characteristic of the inner dome 15m is the tendency to increase significantly. In FIG. 4H, the click section is finished.

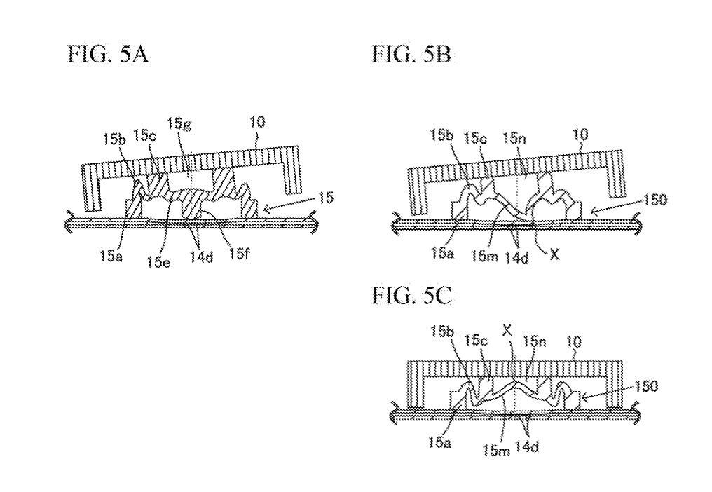

FIG. 5A is a diagram illustrating a deformation state of the dome rubber 15 according to the present embodiment when the key top 10 is inclined. FIG. 5B is a diagram illustrating a deformation state of the dome rubber 150 when the key top 10 has been inclined and the inner dome 15m has caused buckling deformation. FIG. 5C is a diagram illustrating a deformation state of the dome rubber 150 when the inner dome 15m has inverted.

When a corner of the key top 10 is depressed and the key top 10 is tilted, the load is not applied evenly left and right to the outer dome 15b and the inner dome 15m of the dome rubber 150, and hence the inner dome 15m may cause the buckling deformation as illustrated in FIG. 5B. When the key top 10 is depressed beyond the stroke end, the inner dome 15m of the dome rubber 150 is reversed as illustrated in FIG. 5C and may not return to an original shape.

On the contrary, in the dome rubber 15, even when the corner of the key top 10 is depressed and the key top 10 is tilted, since the projection 15f is provided in the center of the bowl part 15e, the projection 15f serves as a fulcrum without causing the buckling deformation and depresses the contact 14d as illustrated in FIG. 5A. Therefore, the dome rubber 15 can depress the contact 14d without being affected by the inclination of the key top 10.

As described above, the dome rubber 15 includes: the outer dome 15b that gives the reaction force to the key top 10 according to the depression of the key top 10; and the inner dome 15d that is formed integrally with the outer dome 15b, and includes the hemispherical bowl part 15e disposed inside the outer dome 15b, and the projection 15f extending downward from the center of the bowl part 15e and depressing the contact 14d disposed below the key top 10. Thereby, even when the corner of the key top 10 is depressed and the key top 10 is tilted, since the projection 15f serves as the fulcrum and depresses the contact 14d, the contact 14d is turned on in the process of decreasing a depression load of the key top 10, which makes the operation feeling and the contact depression operation sufficiently correspond to each other.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A reaction force generating member comprising:
a first dome that gives a reaction force to an operation member according to the depression of the operation member; and
a second dome that includes a hemispherical bowl part disposed inside the first dome, and a projection projecting downward from the center of the bowl part and depressing a switch disposed below the operation member.

2. The reaction force generating member as claimed in claim 1, wherein
the first dome performs buckling deformation, and the second dome never performs the buckling deformation.

3. The reaction force generating member as claimed in claim 2, wherein
the projection is in contact with the switch simultaneously with or immediately after the first dome performs the buckling deformation.

4. The reaction force generating member as claimed in claim 1, wherein
the second dome has a load displacement characteristic lower in a load increase rate than a load displacement characteristic in which a depression load linearly increases according to a depression amount of the operation member.

5. The reaction force generating member as claimed in claim 1, wherein
the first dome has a first load displacement characteristic in which a depression load of the operation member increases until the first dome performs buckling deformation according to the depression of the operation member, and the depression load of the operation member decreases after the buckling deformation,
the second dome has a second load displacement characteristic in which the depression load of the operation member increases according to the depression amount of the operation member, and
when the depression load of the operation member in the total of the first and the second load displacement characteristics of the first dome and the second dome decreases, the projection turns on the switch.

6. A key switch device comprising:
an operation member to be depressed;
a switch disposed under the operation member; and
a reaction force generating member, provided between the operation member and the switch, including:
a first dome that gives a reaction force to an operation member according to the depression of the operation member; and
a second dome that includes a hemispherical bowl part disposed inside the first dome, and a projection projecting downward from the center of the bowl part and depressing a switch disposed below the operation member.
